(19) United States
(12) Patent Application Publication
(10) Pub. No.: US 2023/0368261 A1
(43) Pub. Date: Nov. 16, 2023

(54) VEHICLE MATCHING SYSTEM AND METHOD

(71) Applicants: Chris Avery, Calgary (CA); Arthur Lim, Calgary (CA); Peter Pastor, Calgary (CA); Ted Lam, Calgary (CA)

(72) Inventors: Chris Avery, Calgary (CA); Arthur Lim, Calgary (CA); Peter Pastor, Calgary (CA); Ted Lam, Calgary (CA)

(21) Appl. No.: 17/742,290

(22) Filed: May 11, 2022

(51) Int. Cl. G06Q 30/06; G06Q 10/08

(52) U.S. Cl. CPC G06Q 30/0627; G06Q 10/0875; G06Q 30/0635

(57) ABSTRACT

A vehicle matching system and method to improve the auto loan process for a borrower and a seller of vehicles, particularly a vehicle dealership. Particularly, the system finds all vehicles in a dealership's inventory database or a provided third party marketplace that are compatible with an auto loan approval and maximizes deals by structuring them in the most profitable manner for the vehicle dealership.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of auto loan software of existing art and more specifically relates to a system and method for matching auto loan borrowers with a compatible vehicle.

### RELATED ART

Often, the purchase of a vehicle requires a loan from an institution, such as a bank. Once the loan has been approved, a compatible vehicle must be found based on terms of the approved loan. This step can be difficult and extremely time consuming for the vehicle dealership, particularly when dealing with subprime/nonprime borrowers with stricter loan terms. This is especially true during vehicle inventory shortages and/or supply chain issues, as many vehicle dealerships are left without inventory to fulfil approvals. Further, typically finance managers or specific finance departments are required to structure the deals to bring maximum profit to the vehicle dealership. Thus, a need exists for a system in which streamlines the process and allows any representative to find compatible vehicles and maximize structure of the deal.

### SUMMARY OF THE INVENTION

In view of the foregoing disadvantages inherent in the known auto loan art, the present disclosure provides a novel vehicle matching system and method. The general purpose of the present disclosure, which will be described subsequently in greater detail, is to provide a system in which finds loan criteria compatible vehicle(s) and maximizes profit in a vehicle loan.

A vehicle matching method is disclosed herein. The vehicle matching method may include receiving, at a system, a first vehicle purchase request, the first vehicle purchase request including request information, the request information including loan information, the loan information including loan criteria; searching, via the system, at least one vehicle inventory database based on the loan information, the at least one vehicle inventory database including vehicle information relating to each of a plurality of vehicles; generating, via the system, a first compatible vehicle list from the at least one vehicle inventory database based on a comparison of the request information and the vehicle information; receiving, via the system, valuation information from at least one source, the valuation information being specific to vehicles on the first compatible vehicle list; performing, via the system, calculations using the request information, the vehicle information and the valuation information to determine base profit criteria and a profitability of each of the vehicles on the first compatible vehicle list; selectively removing, via the system, vehicles from the first compatible vehicle list that do not meet the base profit criteria, thereby creating a second compatible vehicle list; determining, via the system, vehicle purchase term characteristics for vehicles on the second compatible vehicle list based on at least one of the request information, the vehicle information and the valuation information; comparing, via the system, the vehicle purchase term characteristics with the loan criteria; selectively removing, via the system, vehicles from the second compatible vehicle list that do not meet the loan criteria, thereby creating a third compatible list vehicle list; and displaying, via the system, the third compatible list vehicle list to a user of the system.

In some embodiments, a system may be provided for performing the vehicle matching method. The system may include at least one memory storing computer executable instructions and at least one processor configured to execute the computer executable instructions. Execution of the computer executable instructions may cause the at least one processor to perform a vehicle matching method.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, vehicle matching system and method, constructed and operative according to the teachings of the present disclosure.

FIG. 1 is a schematic diagram of a system for vehicle matching, according to an embodiment of the disclosure.

FIG. 2 is a flow diagram of a vehicle matching method, according to an embodiment of the present disclosure.

FIG. 3 is a flow diagram of a vehicle matching method, according to another embodiment of the present disclosure.

FIG. 4 is an exemplary user interface of the system illustrating a final vehicle list being displayed to a user of the system, according to another embodiment of the present disclosure.

FIG. 5 is an exemplary user interface of the system illustrating a deal page, according to another embodiment of the present disclosure.

FIG. 6 is an exemplary user interface of the system illustrating adjustments that can be made in the deal page, according to another embodiment of the present disclosure.

FIG. 7 is an exemplary user interface of the system illustrating adjustments that can be made in the deal page, according to another embodiment of the present disclosure.

FIG. 8 is an exemplary user interface of the system illustrating adjustments that can be made in the deal page, according to another embodiment of the present disclosure.

FIG. 9 is a flow diagram of a vehicle matching method, according to another embodiment of the present disclosure.

FIGS. 10A-10D together form a flow diagram of a vehicle matching method according to another embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to auto loan software and more particularly to a vehicle matching system and method as used to improve the auto loan process for a borrower, particularly a subprime/nonprime borrower, and a seller of vehicles, particularly a vehicle dealership. Generally, the vehicle matching system and method may find all compatible vehicles for a provided auto loan approval and maximizes deals by structuring them in the most profitable manner for the vehicle dealership. The system also provides efficiency for the dealership, allowing any representative to use the system to find compatible vehicles and maximize deals. Further, a marketplace may be provided to provide inventory to dealerships who do not have matching vehicles for their approvals. The marketplace may enable private sellers to list their vehicles on the marketplace and provide them with customers having pre-approved finance, negating a need to negotiate.

The system may take a variety of conditions associated with a subprime or nonprime auto loan approval and search the dealer's inventory for all compatible vehicles. The system may do this by accounting for a variety of factors such as (but not limited to) black book value; what the vehicle receives in regard to percentage of the black book value based on year and mileage; negative equity; and dealership cost on the vehicle. Payment call amount may then be provided and calculated to ensure that a provided interest rate (calculated by the system) is under the maximum payment call amount. Finally, the system may assure dealers a predesignated profit amount (as specified by the dealer using the system) that accommodates both payment call amount and max loan amounts provided in the auto loan approval.

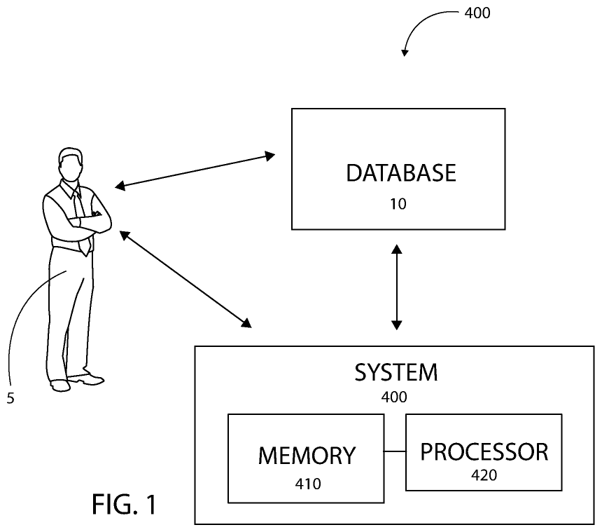

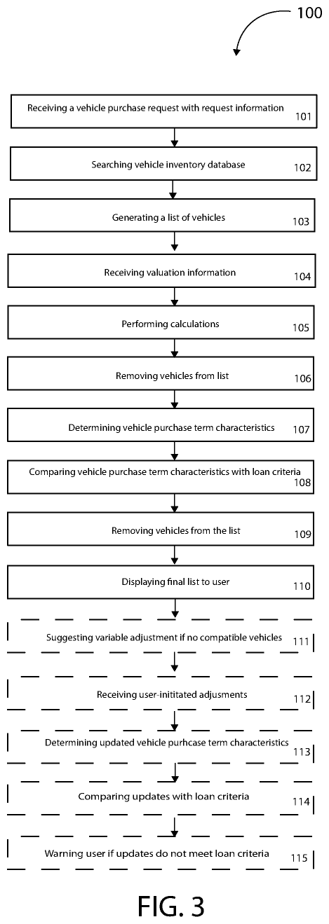

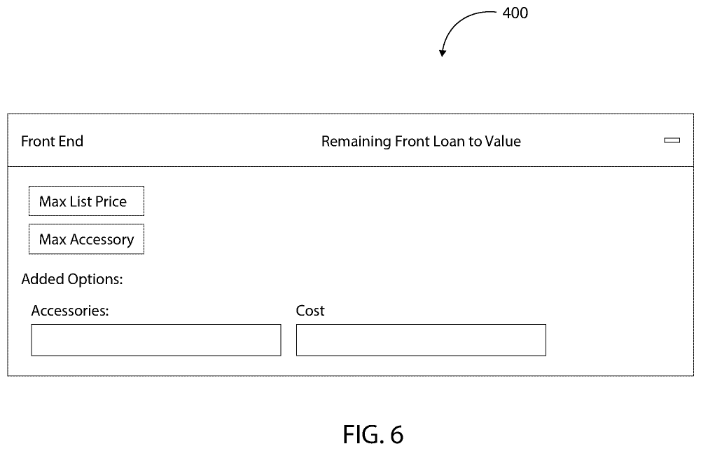

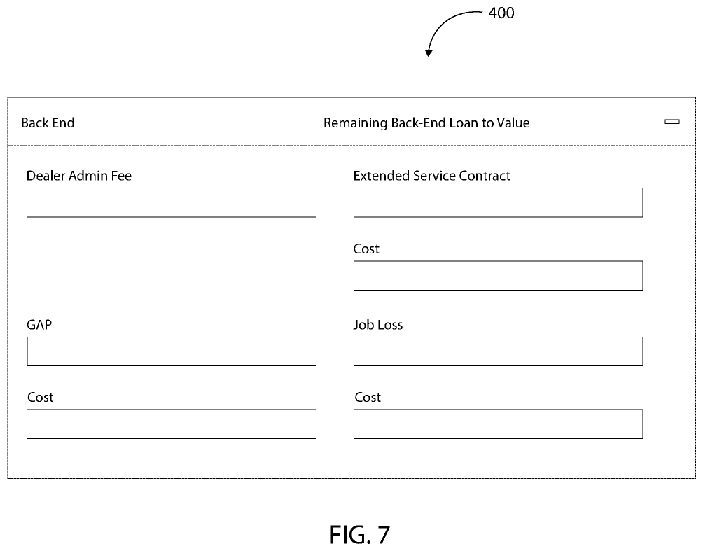

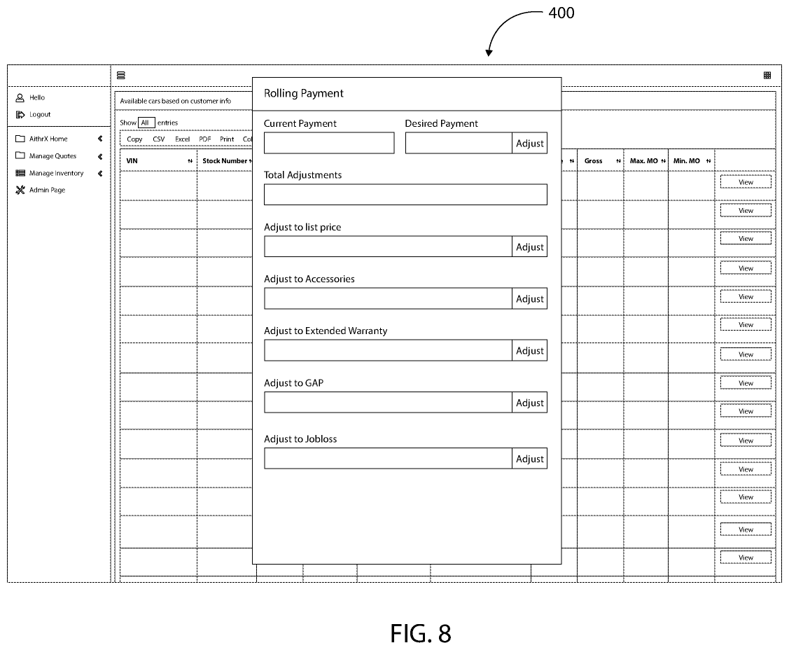

Referring now more specifically to the drawings by numerals of reference, there is shown in FIGS. 1-10D, various views and flow diagrams of a system 400 and vehicle matching methods 100, 200, 300. As shown in FIG. 1, the system 400 for vehicle matching may include at least one memory 410 and at least one processor 420. The memory 410 may store computer executable instructions which the at least one processor 420 may be configured to execute. Execution of the computer executable instructions may cause the at least one processor 420 to perform the vehicle matching method(s). As shown in FIG. 1, the system 400 may be configured to integrate with at least one at least one vehicle inventory database 10, which will be discussed in more detail below.

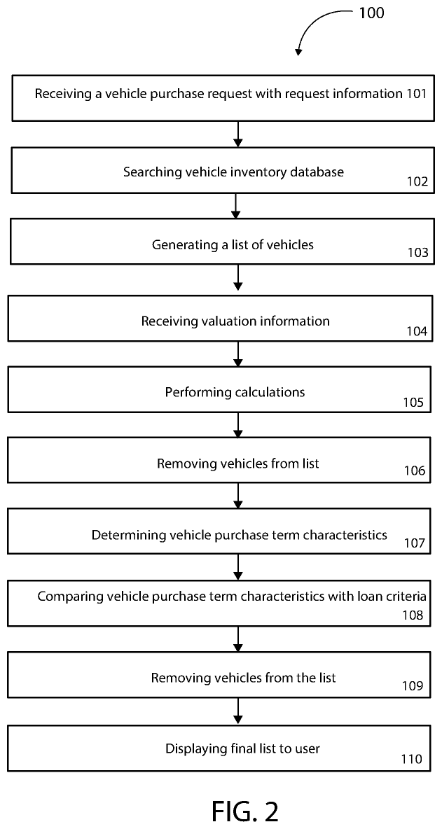

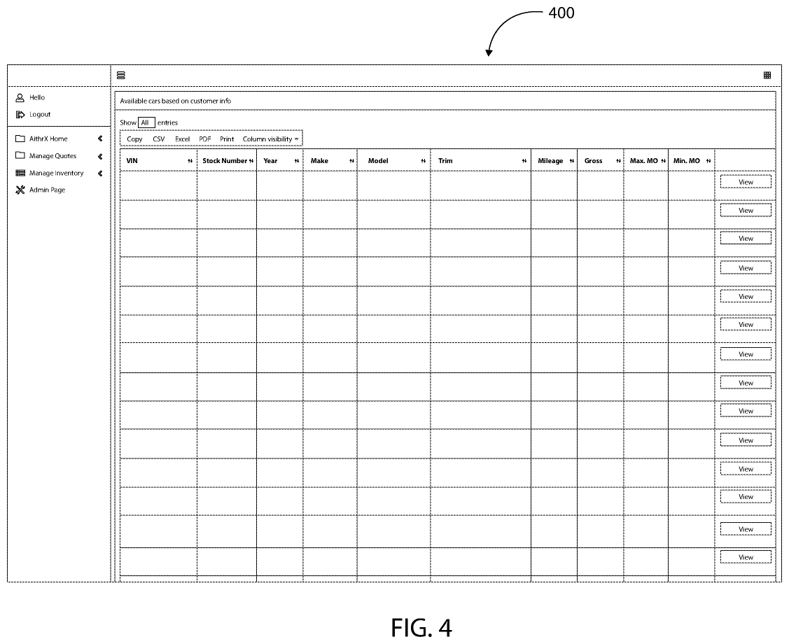

The system 400 may find for a borrower a compatible vehicle whilst also maximizing profit for a seller of the vehicle. FIGS. 2-3 and FIGS. 9-10C in particular illustrate vehicle matching method(s). In some embodiments, the system 400 may include a portal at which a user 5 of the system 400 may first be prompted to log in (using their credentials), or the system 400 may recognize the user 5 and automatically direct them to a start page (discussed below). An exemplary user interface for the portal is shown in FIGS. 4-8. The memory 410 may include a system database configured to store user credential information (usernames, passwords, email addresses, names, etc.) In some embodiments, the portal may be provided at a website. In another embodiment, the portal may be provided in a software application that may be downloadable to an electronic device such as a smartphone, a desktop computer, a laptop computer, etc.

Once logged in and directed to the ‘start page’ as discussed above, as shown in FIG. 2, the vehicle matching method 100 may comprise the step 101 of receiving (at the system 400) a first vehicle purchase request. This request may be initiated by the user 5 of the system 400, which particularly may be the seller of the vehicle (or more particularly a dealership representative such as a finance manager or salesperson). The vehicle purchase request may include request information. The request information may particularly include loan information (amongst other things discussed below). The loan information may include loan criteria. For example, the loan criteria may include, but is not limited to, lender tier, a lender approved monthly payment, interest rate, maximum loan amount if given, minimum financeable vehicle year, maximum financeable mileage, etc. In some examples, as discussed above, the system 400 and vehicle matching method 100 may be particularly useful for subprime and/or nonprime borrowers. As such, the lender approved monthly payment may include payment call amount. Further, the request information may include borrower information such as (but not limited to) trade in value of previous vehicle (if applicable), lien amount (if applicable), down payment (if applicable), etc.

Next, the system 400 may perform the step 102 of searching the at least one vehicle inventory database 10 based on the request information. The at least one vehicle inventory database 10 includes vehicle information relating to each of a plurality of vehicles. For example, the vehicle information may include (but is not limited to) vehicle identification number, type of vehicle, make of vehicle, vehicle year, mileage, list price, list price, dealer cost (running cost of the vehicle), etc. and as such, the system 400 may be configured to search and determine which vehicles meet the loan criteria. For example, the system 400 may automatically exclude any vehicle with a list price above the maximum loan amount.

In some embodiments, the at least one vehicle inventory database 10 may include at least one dealer database 10 and at least one third party database 10. As such, in some embodiments, the system 400 may be configured to communicate with a dealership's DMS feed to view their inventory. In some embodiments, the at least one third party database 10 may be a marketplace combining a plurality of third party sellers. For example, the plurality of third party sellers may be private or independent sellers. In these embodiments, the system 400 may first search the at least one dealer database 10. If the at least one dealer database 10 has matching vehicles, the system 400 may display stock number for the matching vehicles to the user 5 of the system 400. If the at least one dealer database 10 does not have matching vehicles, the system 400 may then search the at least one third party database 10.

The system 400 may then perform the step 103 of generating a first compatible vehicle list from the at least one vehicle inventory database 10 based on a comparison of the request information and the vehicle information (again excluding vehicles that do not match the loan criteria). In some steps and in some embodiments, the term ‘list’ may refer to a physical list created by the system 400 and viewable by the user of the system 400. In other steps and other embodiments, the term ‘list’ may not refer to a physical/viewable list; instead, the term ‘list’ may be used to aid in clarity of the steps being performed by the system 400 in narrowing down and finding compatible vehicles. This step 103 may be an example of the latter.

The system 400 may then be configured to execute the step 104 of receiving valuation information from at least one source. The valuation information may be specific to vehicles on the first compatible vehicle list. For example, preferably, the valuation information may be information such as (but not limited to) tax information, valuation information, history information, etc. The at least one source third party valuers such as black book; history providers, such as CARFAX®, and the like; tax information providers, etc.

The system 400 may then be configured to execute the step 105 of performing calculations relating to (at least) the request information, the vehicle information and the valuation information. For example, the system 400 may utilize information such as (but not limited to) list price for each of the vehicles on the first compatible vehicle list, lien amount (remaining amount left to be paid to a lender for a loan provided on a trade in vehicle), actual trade in value, equity (whether negative or positive), down payment, lender fee, third party value (such as Black Book Value), front end value, back end value to perform the calculations.

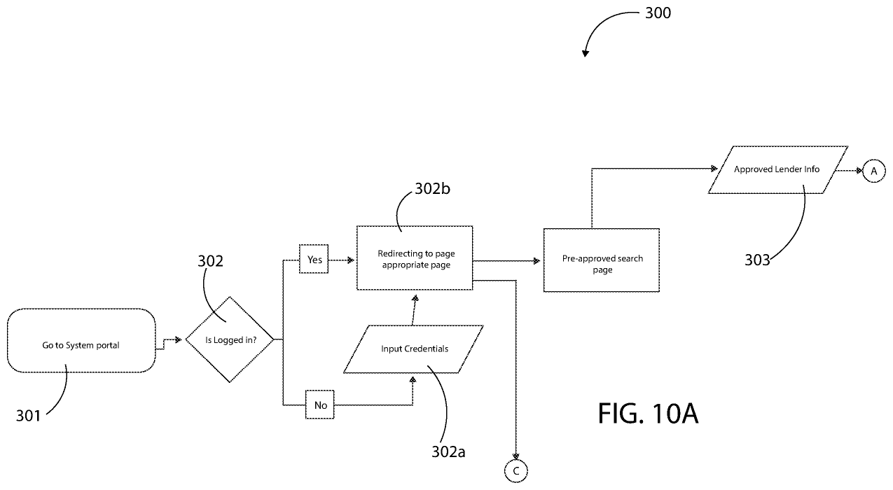

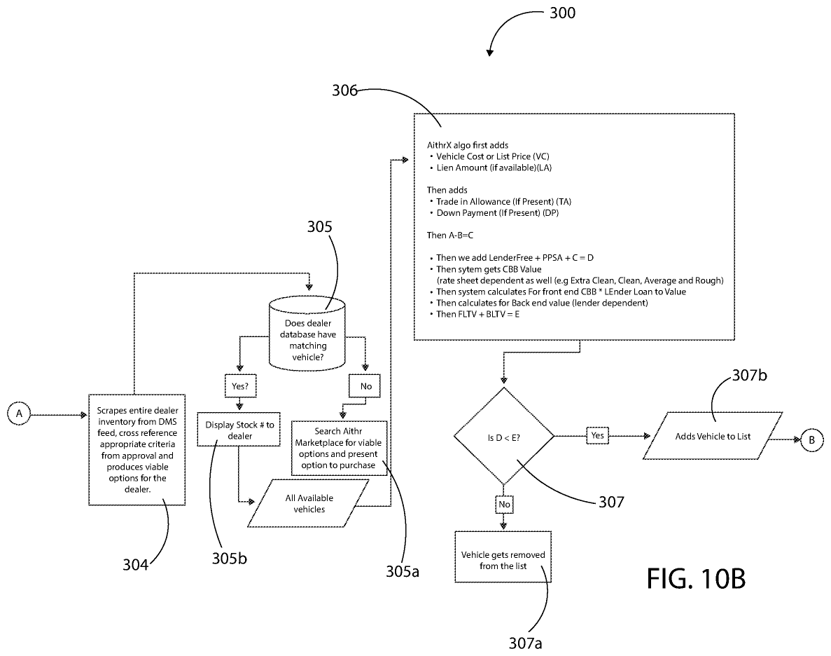

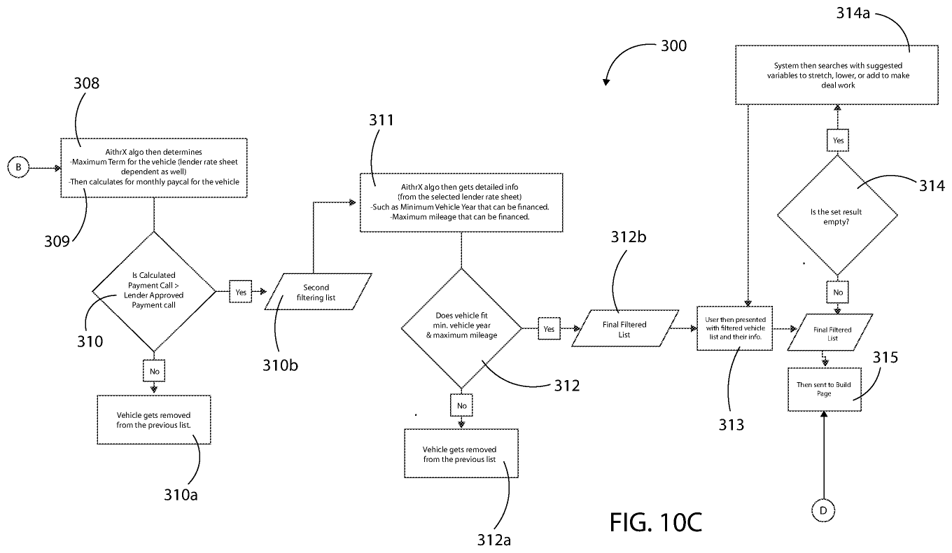

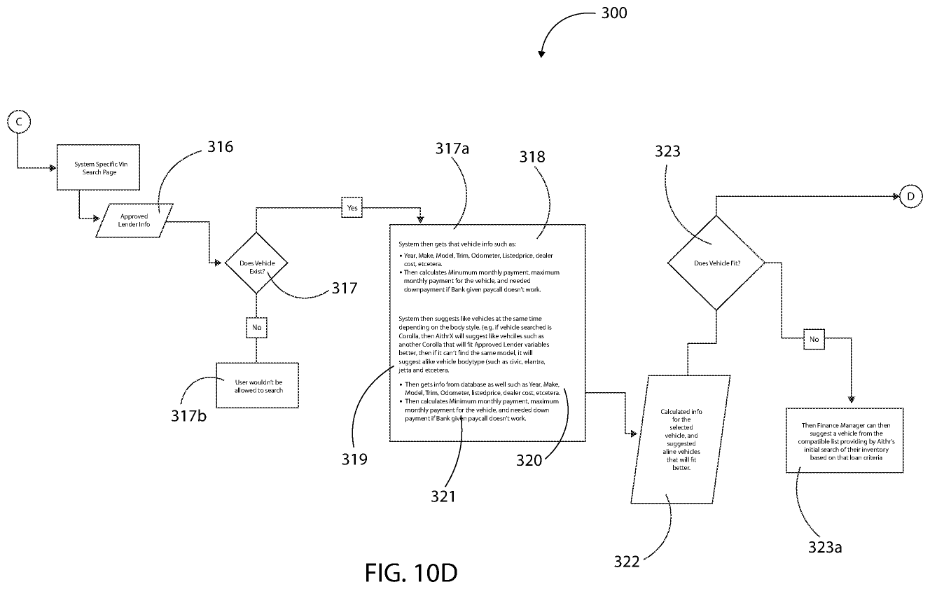

The system 400 may particularly perform the calculations to determine base profit criteria (the amount/number needed for the seller to break even or profit); and a profitability for each of the vehicles on the first compatible vehicle list (whether it is possible to make break even or profit from the vehicle). For example, the system 400 may first add list price for each vehicle that meets the loan criteria as discussed above, to lien amount (if available), which may be referred to as calculation A, as shown in FIG. 10B. For example, the list price may be $43,200 and the lien amount may be $30,000. As such, in this example, calculation A may equal $73,200. The system 400 may then add trade in allowance (if applicable) to down payment (if applicable) which may be referred to as calculation B. For example, the trade in allowance may be $20,000 and down payment may be $8,600. As such, in this example, calculation B may equal $28,600.

The system 400 may then subtract calculation B from calculation A to get calculation C. Using the above example, calculation C may equal $44,700 ($73,200-$28,600). The system 400 may then add a lender fee (contained in the loan information) to any other fee (such as PPSA) and calculation C, to get calculation D. For example, the lender fee may be $500 and other fees may also total $500. As such, in this example, calculation D may be $45,700 ($500+$500+$44,700). These calculations may be the calculations in which help determine the individual profitability of each of the vehicles on the first compatible vehicle list.

The system 400 may then calculate for front end loan-to-value (FLTV) and back end loan-to-value (BLTV). These following calculations may be the calculations which help to determine the base profit criteria. For example, calculation of the FLTV and BLTV may provide a maximum number that Calculation D cannot exceed in order for the vehicle to be profitable. The FLTV may be the maximum amount allowable to be included in a front end portion of the deal (vehicle purchase) based on Black Blook Value (or other third party valuer) and credit tier (contained in the loan information) and the BLTV may be maximum amount allowance to be included in a back end portion of the deal. For example, if the borrower is credit tier 1, the FLTV may be 140% of the Black Book Value (or other party valuer) and the BLTV may be 40% of the Black Book Value (or other party valuer).

The system 400 may then add FLTV and BLTV to get calculation E. This may be the Total Loan to Value. Using the example above wherein the FLTV is 140% and the BLTV is 40%, the Total Loan to Value (or Calculation E) may be 180%. As such, if, for example, the Black Book Value of one of the vehicles on the first compatible vehicle list is $34,500, the FLTV may be $48,200 ($34,500×1.4) and the BLTV may be $13,800 ($34,500×0.4). The Total Loan to Value then (Calculation E in this example) may be $62,100.

As shown in FIG. 2, the system 400 may perform the step 106 of selectively removing vehicles from the first compatible list vehicle list based on the calculations (thereby creating a second compatible vehicle list). The system 400 may do this by determining whether calculation D is lesser than calculation E for each vehicle on the first compatible list vehicle list. If the total amount of calculation D is lesser than calculation E for a particular vehicle, that vehicle is added to the second compatible vehicle list (or removed from the first compatible vehicle list) if calculation D is greater than E for a particular vehicle, that vehicle gets removed from the at least one list. Using the above example wherein Calculation D is $45,700 and Calculation E is $62,100—this vehicle would be added to the second compatible vehicle list. It should be appreciated that these calculations are given as an example, and do not limit the calculations to those discussed here 400.

Next, the system 400 may be perform the step 107 of determining vehicle purchase term characteristics for vehicles on the second compatible vehicle list based on at least one of the request information, the vehicle information and the valuation information. For example, in some embodiments, the vehicle purchase term characteristics may include (but is not limited to) at least one of maximum term, minimum monthly payment, maximum monthly payment and required down payment. As such, in some embodiments, step 107 may include (but is not limited to) the sub-steps of determining maximum term for each of the vehicles on the second compatible vehicle list and calculating a calculated monthly payment for each of the vehicles on the second compatible vehicle list.

The system 400 may then execute the step 108 of comparing the vehicle purchase term characteristics with the loan criteria. For example, the system 400 may compare and determine whether the lender approved monthly payment (or payment call) is greater than or lesser than the calculated monthly payment (or payment call). As such, the system 400 may then execute step 109 of selectively removing vehicles from the second compatible vehicle list that do not meet the loan criteria. For example, if the calculated monthly payment exceeds the lender approved monthly payment for certain vehicles, them vehicles may be removed from the second compatible vehicle list.

As such, a third or ‘final’ compatible vehicle list may then be created. As shown in FIG. 2, the system 400 may at that stage be configured to perform the step 110 of displaying the third list vehicle list to a user 5 of the system 400. In some embodiments, prior to creating the ‘final’ list, the system 400 may perform one more detailed filtering stage. For example, this may include (but is not limited to) determining whether minimum financeable vehicle year is at least equal to the vehicle year for each of the vehicles and determining whether the maximum financeable mileage is at least equal to the mileage for each of the vehicles. As such, the step of selectively removing vehicles 109 may include removing vehicles with vehicle year less than the minimum financeable vehicle year and removing vehicles with mileage greater than the maximum financeable mileage.

For example, if the loan information states that the minimum financeable vehicle year is 2010, vehicles with vehicle years prior to 2010 may be removed. Further, if the loan information states that the maximum financeable mileage is 100,000 miles; vehicles with mileage greater than 100,000 miles may be removed. It should be appreciated that vehicle year and mileage are given as examples of loan information to be compared with vehicle information. The system 400 may utilize any information in the loan information to compare with the vehicle information, ensuring vehicles on the final vehicle list are entirely compatible with the loan criteria.

The final vehicle list may include the vehicle information for each vehicle thereon. For example, vehicle identification number, stock number, vehicle year, make of vehicle, type of vehicle, trim, mileage, maximum term, gross profit, front end and back end allowance, etc. may be displayed to the user 5 of the system 400 for each vehicle, as shown in FIG. 4. Preferably, the final vehicle list may be displayed in order of highest profit to lowest. The user 5 may be able to use adjust what the system 5 displays to them. For example, the user 5 may view photos of the vehicles, top 5 features of the vehicles, select/deselect fields, etc.

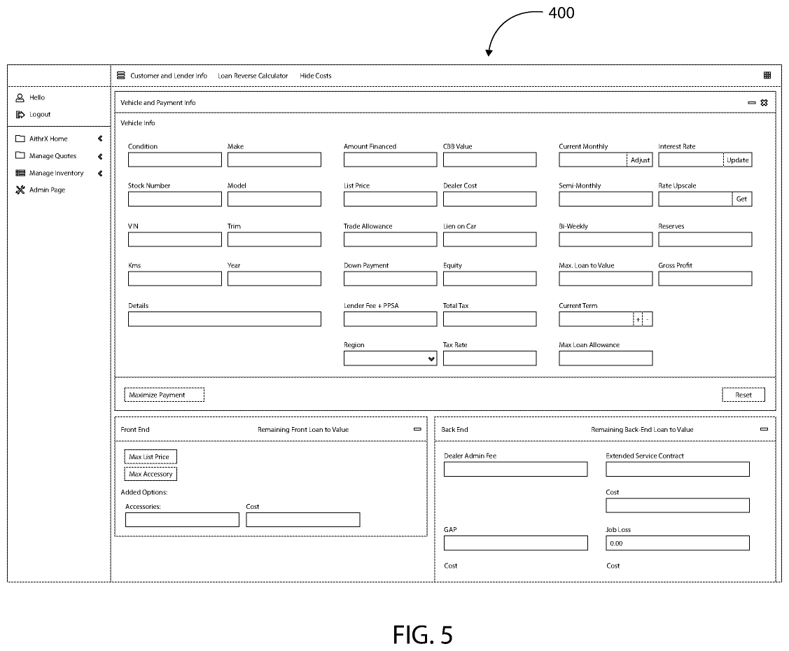

In some embodiments, after the final vehicle list has been displayed to the user 5 of the system 400 and/or once the user 5 has narrowed down to a particular vehicle, the user 5 may enter a ‘build page’ or ‘deal page’ in which the user 5 may adjust variables in order to maximize the structure of the deal, as shown in FIG. 5. From this page, the user 5 may view the vehicle information (discussed above); cost details, such as amount financed, Black Book Value, list price, dealer cost, trade in value, lien amount, down payment, equity, lender fee, PPSA, total tax, tax region, tax rate; payment details such as interest rate, payment amounts (based on frequency), rate upsale, reserves, total loan to value, gross profit, current term, maximum loan allowance; front end loan to value; and back end loan to value.

Adjustments may be made by the user 5, as shown in FIGS. 5-8. As such, the system 400 may be configured to perform the step 112 of receiving at least one user-initiated adjustment to at least one of the vehicle purchase term characteristics, the vehicle information or the request information; step 113 determining updated vehicle purchase term characteristics based on the at least one user-initiated adjustment; step 114 comparing the updated vehicle purchase term characteristics with at least one of the loan criteria or the base profit criteria; and step 115 warning the user of the system when the updated vehicle purchase term characteristics do not meet the at least one of the loan criteria or the base profit criteria. For example, the list price of the vehicle (vehicle information) may be adjusted, and system 400 may (for example) may update monthly payment (vehicle purchase term characteristic) for the vehicle accordingly. The system 400 may also warn the user 5 if this adjustment goes over the front end value allowance (loan criteria). Further, the system 400 may consider negative equity and vehicle loan to value, compare to maximum loan amount and adjust vehicle purchase term characteristics such as total cost, extended products, etc. whilst considering the loan information (rules specific to the lender) to maximize profit and equity covered.

In some embodiments, the system 400 may perform the step 111 of suggesting at least one variable adjustment to at least one of the vehicle purchase term characteristics, the vehicle information and the request information. This may be done throughout the deal page stage, and/or when none of the plurality of vehicles match the loan criteria. For example, if the third or ‘final’ compatible vehicle list is empty, the system 400 may suggest adjustments to make in order to find compatible vehicles. For example, the system 400 may suggest adjusting interest rates (for example reducing interest rate), stretching finance term (for example extending the finance term), and/or increasing/decreasing down payment based on what is required for amount financed.

The system 400 may consider all variable lender rules to maximize profit. For example, the system 400 may determine where to include variables such a lender fee in the front or back of the deal based on the given lender's rulesets. In another example, the system 400 may determine where to include documentation fees in the front or back of a deal. This may affect profit structure greatly, and as such, the system 400 may prevent human error in this regard.

In additional examples, the build page may enable the user 5 to adjust back end products (and the system 400 may warn the user 5 if the adjustment goes over the back end value allowance); front end (again, the system 400 may warn if the adjustment goes over the front end allowance); calculate taxes; apply specific savings; and utilize certain functions. For example, the user 5 (aided by the system 400) may structure back end products to maximize remaining Loan to Value allowed by the loan approval. These products may include dealer admin fee, extended service contract, Guaranteed Asset Protection (GAP) Policies, Job Loss Policy, etc. The user 5 (aided by the system 400) may also structure the front end of the deal. For example, list price may also be changed. Further, in some embodiments, the system 400 may suggest a specific sale price of the vehicle after considering accessories added, and other applicable fees.

In some embodiments, the system 400 may include a roll payment function, a max list price function and a max accessory function. The roll payment function may suggest the adjustments. For example, if calculated payment call is $850, but the desired payment call is $800, the system 400 may calculate value difference and suggest where to deduct (for example the list price or extended products). In another example, if calculated payment call is $850 but desired is $875, the system 400 may suggest where to put the value. The equity checker function may provide the ability to adjust front and back end allowance and allocate allowance to match if there is a negative equity, thus maximizing the seller profit (whilst adhering to lender rules [in the loan information]). The max list price function may adjust list price according to front end allowance. Further, the max list price function may determine whether a lender admin fee must be added.

The roll payment function may include increasing certain components of the deal to maximize the total allowable amount per month based on the loan criteria (thereby maximizing the deal). For example, if monthly payment is $534 at $11,998 List Price, rolling payment to $550 means increasing list price to $13,998. Rolling the payment may involve increasing the value of one or multiple attributes of the deal such as list price, gap policy, extended warranty etc. By Choosing “Adjust” payment option within payment details on the build/deal page, the system 400 may provide multiple suggestions on how to change the structure of the front end the deal to achieve desired payment. This may adjust the following values: List Price, Accessories, Extended Warranty, Gap Policy, Job Loss, etc.

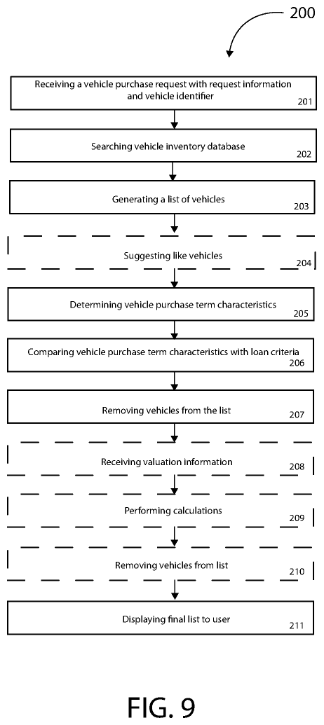

Referring now to FIG. 9, as shown, the vehicle matching method 200 may further include steps taken by the system 400 when the borrower has a particular vehicle in mind. As such, the method 200 begins with the step 201 of receiving a second vehicle purchase request. The second vehicle purchase request may be made at the same time as the first vehicle purchase request. For example, the system 400 may run the steps 101-110 discussed above simultaneously with the following steps. The second vehicle purchase request may include the request information and at least one vehicle identifier relating to at least one desired vehicle. For example, the at least one vehicle identifier may be a vehicle identification (VIN) number for the vehicle. In another example, the at least one vehicle identifier may be make or model of the vehicle.

The system 400 may then begin searching 202, the at least one vehicle inventory database based on the request information and the at least one vehicle identifier; and generating 203, at least one first selected vehicle list based on a comparison the vehicle identifier and/or the request information with the vehicle information. For example, if the at least one vehicle identifier is the VIN number, the system 400 may search through the vehicle information for the VIN number and as such the at least one first selected vehicle list may include at least one desired vehicle. If the at least one vehicle identifier is a make and model of vehicle, the system 400 may search through the vehicle information for the particular make and model and the at least one first selected vehicle list may include all vehicles in the at least one inventory database including the desired make and model. If the at least one desired vehicle does not meet the loan criteria, the system 400 may suggest, as above, at least one variable adjustment to at least one of the vehicle purchase term characteristics, the vehicle information or the request information in order for the at least one desired vehicle to be compatible.

In some embodiments, the system 400 may also perform the step 204 of suggesting at least one suggested vehicle based on a comparison of the at least one vehicle identifier, the vehicle information and the request information. For example, if there are no vehicles matching the at least one desired vehicle or if the loan criteria do not allow for the at least one desired vehicle, the system 400 may suggest vehicles that are similar to that at least one desired vehicle. For instance, the system 400 may take the 5 most pertinent features of the at least one desired vehicle and search the at least one inventory database to find the at least one suggested vehicle.

The system 400 may then perform the step 205 of determining the vehicle purchase term characteristics for the at least one desired vehicle and/or the at least one suggested vehicle based on the at least one of the request information or the vehicle information. For example, the system 400 may determine minimum monthly payment, maximum monthly payment, needed down payment, etc. Then, comparing 206, the vehicle purchase term characteristics with the loan criteria; selectively removing vehicles from at least one first selected vehicle list that do not meet the loan criteria 207, thereby creating a second selected vehicle list; and displaying 211 the second or ‘final’ selected vehicle list to the user 5 of the system 400.

In some embodiments, the system 400 may also perform the steps of receiving 208 the valuation information from the at least one source, the valuation information being specific to vehicles on the second selected vehicle list; performing 209 calculations with the request information, the vehicle information and the valuation information to determine the base profit criteria and the probability of the vehicles; selectively removing 210 vehicles from the second selected vehicle list based on the mathematical calculations, thereby creating a third selected vehicle list; and displaying 211, via the system, the third or ‘final’ selected vehicle list to the user 5 of the system 400. If all vehicles, or the at least one desired vehicle and/or the at least one suggested vehicle do not meet the loan criteria and/or the base profit criteria, the user 5 may then be able to use the final compatible vehicle list discussed above in step 110, as the first vehicle purchase request runs simultaneously.

Referring specifically to FIGS. 10A-10D together forming a flow diagram illustrating a vehicle matching method 300 according to an embodiment of the present disclosure. Markers A, B, C and D are used merely for correlating the diagrams. As shown, the vehicle matching method 300 may include the step 301 of logging into the portal and step 302 determining at the portal whether the user 5 is logged in, and inputting credentials if not logged in 302a; and redirecting to appropriate page if logged in 302b (FIG. 10A). Step 303 may include inputting request information (including lender information) into the system 400, and as such, the system 400 searches at least one dealer database 304; and determines whether the at least one dealer database 10 has a matching vehicle 305. If no, the system 400 then searches at least one third party database 305a; if yes, the system 400 provides stock number to the user 305b. As shown in FIG. 10B, the system 400 then may perform the step 306 of performing calculations (as discussed above) and making determinations based on the calculations (such as if calculation D is lesser than calculation E) 307. If no, the vehicle may be removed from a list 307a; if yes, the vehicle may be added to the list 307b.

As shown in FIG. 10C, the system 400 may then determine minimum term for vehicles on the list 308; and calculate monthly payment call for vehicles on the list 309. The system 400 may then determine if calculated monthly payment is lesser than lender approved payment call 310; if no, the vehicle may be removed from the list 310a, if yes, the vehicle may be added to the list 310b. The system 400 may then receive detailed information from the loan information 311 (such as minimum financeable vehicle year and maximum financeable mileage as discussed above); and determine if the vehicles on the list meet the loan criteria 312; if no, the vehicle may be removed from the list 312a, if yes, the vehicle may be added to the list 312b and a final list may be displayed to the user 313 (FIG. 10C). The system 400 may determine if the final list is empty 314. If yes, the system 400 may automatically search the at least one vehicle inventory database with suggested variable adjustments (as discussed above) 314a and display the final list to the user. The user may then utilize the build page or deal page 315 as discussed above to maximize the structure of the deal.

As shown in FIG. 10D and as discussed above, the system 400 may also be used for searching for specific vehicles. As such, in some embodiments once the user is logged in, step 316 may include inputting the request information into the system 400, and as such, the system 400 searches the at least one vehicle inventory database to determine whether the vehicle exists 317. If yes, the system 400 may then receive vehicle information 317a and calculate minimum monthly payment, maximum monthly payment and needed down payment 318. If no, the system 400 may not allow the user to search 317b. Simultaneously, the system 400 may suggest similar vehicles 318; receive the vehicle information 320; and calculate minimum monthly payment, maximum monthly payment and needed down payment for the suggested vehicles 321. The system 400 may then perform the calculations as discussed above 322 (determining base profit criteria and profitability of the vehicles) and determine whether the vehicle(s) meet the criteria 323. If the vehicle does not meet the criteria, a vehicle from the final list discussed in step 313 may be suggested by the user 323a. If the vehicle does meet the criteria, the user 5 may directed to the build page, as in step 315.

It should be noted that certain steps are optional steps and may not be implemented in all cases. Optional steps are illustrated using dotted lines in FIG. 2 and FIG. 9 so as to distinguish them from the other steps. It should also be noted that the steps described in the vehicle matching method(s) can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for vehicle matching are taught herein.

Whilst the present disclosure specifically discusses the application of the system/method with vehicle/auto loans, it should be appreciated that the system and methods performed by the system may not be limited to solely vehicle/auto loans.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A vehicle matching method comprising:
receiving, at a system, a first vehicle purchase request, the first vehicle purchase request including request information, the request information including loan information, the loan information including loan criteria;
searching, via the system, at least one vehicle inventory database based on the loan information, the at least one vehicle inventory database including vehicle information relating to each of a plurality of vehicles;
generating, via the system, a first compatible vehicle list from the at least one vehicle inventory database based on a comparison of the request information and the vehicle information;
receiving, via the system, valuation information from at least one source, the valuation information being specific to vehicles on the first compatible vehicle list;
performing, via the system, calculations using the request information, the vehicle information and the valuation information to determine base profit criteria and a profitability of each of the vehicles on the first compatible vehicle list;
selectively removing, via the system, vehicles from the first compatible vehicle list that do not meet the base profit criteria, thereby creating a second compatible vehicle list;
determining, via the system, vehicle purchase term characteristics for vehicles on the second compatible vehicle list based on at least one of the request information, the vehicle information and the valuation information;
comparing, via the system, the vehicle purchase term characteristics with the loan criteria;
selectively removing, via the system, vehicles from the second compatible vehicle list that do not meet the loan criteria, thereby creating a third compatible list vehicle list; and
displaying, via the system, the third compatible list vehicle list to a user of the system.

2. The vehicle matching method of claim 1, further comprising the step of:
receiving, at the system, a second vehicle purchase request, the second vehicle purchase request including the request information and at least one vehicle identifier, the at least one vehicle identifier relating to at least one desired vehicle;
searching, via the system, the at least one vehicle inventory database based on the request information and the at least one vehicle identifier, the at least one vehicle inventory database including the vehicle information relating to the plurality of vehicles;
generating, via the system, at least one first selected vehicle list based on a comparison of at least one of the at least one vehicle identifier and the request information with the vehicle information, the at least one first selected vehicle list including at least one of the at least one desired vehicle and at least one suggested vehicle;
determining, via the system, the vehicle purchase term characteristics for vehicles on the at least one first selected vehicle list based on the at least one of the request information and the vehicle information;
comparing, via the system, the vehicle purchase term characteristics with the loan criteria;
selectively removing, via the system, vehicles from at least one first selected vehicle list that do not meet the loan criteria, thereby creating a second selected vehicle list; and
displaying, via the system, the second selected vehicle list to the user of the system.

3. The vehicle matching method of claim 2, further comprising the step of:
receiving, via the system, the valuation information from the at least one source, the valuation information being specific to the vehicles on the at least one second selected vehicle list;
performing, via the system, calculations using the request information, the vehicle information and the valuation information to determine the base profit criteria and the profitability of the vehicles on the at least one second selected vehicle list;
selectively removing, via the system, vehicles from the second selected vehicle list that do not meet the base profit criteria, thereby creating a third selected vehicle list; and
displaying, via the system, the third selected vehicle list to the user of the system.

4. The vehicle matching method of claim 3, further comprising the step of:
suggesting, via the system, at least one variable adjustment to at least one of the vehicle purchase term characteristics, the vehicle information and the request information when none of the plurality of vehicles match at least one of the loan criteria and the base profit criteria.

5. The vehicle matching method of claim 4, further comprising the step of:
receiving, at the system, at least one user-initiated adjustment to at least one of the vehicle purchase term characteristics, the vehicle information and the request information; and
on the at least one user-initiated adjustment;
comparing, via the system, the updated vehicle purchase term characteristics with the loan criteria; and
warning the user of the system when the updated vehicle purchase term characteristics do not meet at least one of the loan criteria and the base profit criteria.

6. The vehicle matching method of claim 5, further comprising the step of:
suggesting, via the system, the at least one suggested vehicle based on a comparison of the at least one vehicle identifier, the vehicle information and the request information.

7. The vehicle matching method of claim 6, wherein the vehicle purchase term characteristics include at least one of maximum term, minimum monthly payment, maximum monthly payment and required down payment.

8. The vehicle matching method of claim 7, wherein the at least one vehicle inventory database includes at least one dealer database.

9. The vehicle matching method of claim 8, wherein the at least one vehicle inventory database further includes at least one third party database.

10. A system for vehicle matching comprising:
at least one memory storing computer executable instructions; and
at least one processor configured to execute the computer executable instructions, execution of the computer executable instructions causing the at least one processor to perform a vehicle matching method, the vehicle matching method comprising:
receiving, at the system, a first vehicle purchase request, the first vehicle purchase request including request information, the request information including loan information, the loan information including loan criteria;
searching, via the system, at least one vehicle inventory database based on the loan information, the at least one vehicle inventory database including vehicle information relating to each of a plurality of vehicles;
generating, via the system, a first compatible vehicle list from the at least one vehicle inventory database based on a comparison of the request information and the vehicle information;
receiving, via the system, valuation information from at least one source, the valuation information being specific to vehicles on the first compatible vehicle list;
performing, via the system, calculations using the request information, the vehicle information and the valuation information to determine base profit criteria and profitability of the vehicles on the first compatible vehicle list;
selectively removing, via the system, vehicles from the first compatible vehicle list that do not meet the base profit criteria, thereby creating a second compatible vehicle list;
determining, via the system, vehicle purchase term characteristics for vehicles on the second compatible vehicle list based on at least one of the request information, the vehicle information and the valuation information;
comparing, via the system, the vehicle purchase term characteristics with the loan criteria;
selectively removing, via the system, vehicles from the second compatible vehicle list that do not meet the loan criteria, thereby creating a third compatible list vehicle list; and
displaying, via the system, the third compatible list vehicle list to a user of the system.

11. The system of claim 10, further comprising the step of:
receiving, at the system, a second vehicle purchase request, the second vehicle purchase request including the request information and at least one vehicle identifier, the at least one vehicle identifier relating to at least one desired vehicle;
searching, via the system, the at least one vehicle inventory database based on the request information and the at least one vehicle identifier, the at least one vehicle inventory database including the vehicle information relating to the plurality of vehicles;
generating, via the system, at least one first selected vehicle list based on a comparison of at least one of the at least one vehicle identifier and the request information with the vehicle information, the at least one first selected vehicle list including at least one of the at least one desired vehicle and at least one suggested vehicle;
determining, via the system, the vehicle purchase term characteristics for vehicles on the at least one first selected vehicle list based on the at least one of the request information and the vehicle information;
comparing, via the system, the vehicle purchase term characteristics with the loan criteria;
selectively removing, via the system, vehicles from at least one first selected vehicle list that do not meet the loan criteria, thereby creating a second selected vehicle list; and
displaying, via the system, the second selected vehicle list to the user of the system.

12. The system of claim 11, further comprising the step of:
receiving, via the system, the valuation information from the at least one source, the valuation information being specific to the vehicles on the at least one second selected vehicle list;
performing, via the system, calculations using the request information, the vehicle information and the valuation information to determine the base profit criteria and the profitability of the vehicles on the at least one second selected vehicle list;
selectively removing, via the system, vehicles from the second selected vehicle list that do not meet the base profit criteria, thereby creating a third selected vehicle list; and
displaying, via the system, the third selected vehicle list to the user of the system.

13. The system of claim 12, further comprising the step of:
suggesting, via the system, at least one variable adjustment to at least one of the vehicle purchase term characteristics, the vehicle information and the request information when none of the plurality of vehicles match at least one of the loan criteria and the base profit criteria.

14. The system of claim 13, further comprising the step of:
receiving, at the system, at least one user-initiated adjustment to at least one of the vehicle purchase term characteristics, the vehicle information and the request information; and
determining, via the system, updated vehicle purchase term characteristics based on the at least one user-initiated adjustment;
comparing, via the system, the updated vehicle purchase term characteristics with the loan criteria; and
warning the user of the system when the updated vehicle purchase term characteristics do not meet at least one of the loan criteria and the base profit criteria.

15. The system of claim 14, further comprising the step of:
suggesting, via the system, the at least one suggested vehicle based on a comparison of the at least one vehicle identifier, the vehicle information and the request information.

16. The system of claim 15, wherein the vehicle purchase term characteristics include at least one of maximum term, minimum monthly payment, maximum monthly payment and required down payment.

17. The system of claim 16, wherein the at least one vehicle inventory database includes at least one dealer database.

18. The system of claim 17, wherein the at least one vehicle inventory database further includes at least one third party database.

19. A vehicle matching method comprising:
receiving, at a system, a first vehicle purchase request, the first vehicle purchase request including request information, the request information including loan information, the loan information including loan criteria;
searching, via the system, at least one of at least one dealer database and at least one third party database based on the request information, the at least one vehicle inventory database including vehicle information relating to each of a plurality of vehicles;
generating, via the system, a first compatible vehicle list from the at least one vehicle inventory database based on a comparison of the request information and the vehicle information;
receiving, via the system, valuation information from at least one source, the valuation information being specific to vehicles on the first compatible vehicle list;
performing, via the system, calculations using the request information, the vehicle information and the valuation information to determine base profit criteria and a profitability of the vehicles on the first compatible vehicle list;
selectively removing, via the system, vehicles from the first compatible vehicle list that do not meet the base profit criteria, thereby creating a second compatible vehicle list;
determining, via the system, vehicle purchase term characteristics for vehicles on the second compatible vehicle list based on at least one of the request information, the vehicle information and the valuation information, the vehicle purchase term characteristics including at least one of maximum term, minimum monthly payment, maximum monthly payment and required down payment;
comparing, via the system, the vehicle purchase term characteristics with the loan criteria;
selectively removing, via the system, vehicles from the second compatible vehicle list that do not meet the loan criteria, thereby creating a third compatible list vehicle list;
selectively displaying, via the system, the third compatible list vehicle list to a user of the system;
suggesting, via the system, at least one variable adjustment to at least one of the vehicle purchase term characteristics, the vehicle information and the request information when none of the plurality of vehicles match at least one of the loan criteria and the base profit criteria;
receiving, at the system, at least one user-initiated adjustment to at least one of the vehicle purchase term characteristics, the vehicle information and the request information;
determining, via the system, updated vehicle purchase term characteristics based on the at least one user-initiated adjustment;
comparing, via the system, the updated vehicle purchase term characteristics with the loan criteria; and
warning the user of the system when the updated vehicle purchase term characteristics do not meet at least one of the loan criteria and the base profit criteria.

20. The vehicle matching method of claim 19, further comprising the step of:
receiving, at the system, a second vehicle purchase request, the second vehicle purchase request including the request information and at least one vehicle identifier, the at least one vehicle identifier relating to at least one desired vehicle;
searching, via the system, the at least one vehicle inventory database based on the request information and the at least one vehicle identifier, the at least one vehicle inventory database including the vehicle information relating to the plurality of vehicles;
generating, via the system, at least one first selected vehicle list based on a comparison of at least one of the at least one vehicle identifier and the request information with the vehicle information, the at least one first selected vehicle list including at least one of the at least one desired vehicle and at least one suggested vehicle;
suggesting, via the system, the at least one suggested vehicle based on a comparison of the at least one vehicle identifier, the vehicle information and the request information;
determining, via the system, the vehicle purchase term characteristics for vehicles on the at least one first selected vehicle list based on the at least one of the request information and the vehicle information;
comparing, via the system, the vehicle purchase term characteristics with the loan criteria;
selectively removing, via the system, vehicles from at least one first selected vehicle list that do not meet the loan criteria, thereby creating a second selected vehicle list;
receiving, via the system, the valuation information from the at least one source, the valuation information being specific to the vehicles on the at least one second selected vehicle list;
performing, via the system, calculations using the request information, the vehicle information and the valuation information to determine base profit criteria and a profitability of the vehicles on the at least one second selected vehicle list;
selectively removing, via the system, vehicles from the second selected vehicle list that do not meet the base profit criteria, thereby creating a third selected vehicle list; and
displaying, via the system, the third selected vehicle list to the user of the system.
